(19) United States
(12) Patent Application Publication
(10) Pub. No.: US 2012/0186458 A1
(43) Pub. Date: Jul. 26, 2012

(54) Filter Fence

(76) Inventor: Thomas Helvey, Houston, TX (US)

(21) Appl. No.: 13/084,224

(22) Filed: Apr. 11, 2011

Related U.S. Application Data
(60) Provisional application No. 61/436,386, filed on Jan. 26, 2011.

(51) Int. Cl. A47J 31/02; B01D 35/30

(52) U.S. Cl. 99/306; 210/232

(57) ABSTRACT

An architecture is presented that provides a reusable, easy to manufacture and use filter fence for retaining a filter within a filter basket to prevent the same from collapsing inward within a filter basket during a beverage brewing process.

### CROSS-REFERENCE

This application claims priority from Provisional patent application Ser. No. 61/436,386 filed Jan. 26, 2011.

### BACKGROUND

Many individuals rely upon a cup of freshly brewed coffee, tea or other brewed beverage to start their morning, or to maintain the individual's energy level throughout the day. One common method of brewing coffee, tea and the like is to use a drip coffeepot or coffeemaker of a type commonly known in the art. Said coffeemakers typically involve passing heated water through a coffee filter containing coffee grounds, tea leaves or other substance to be brewed in such a manner as to flavor the heated water, thereby transforming it into the desired beverage, while preferably retaining the coffee grounds, tea leaves or other brewed substance in the coffee filter.

Coffee filters, which are typically made of paper or crepe paper, oftentimes have a generally cup or bowl-like shape comprised of a unitary filter base and a continuous filter wall rising upward from the filter base for insertion into the filter basket of the coffeemaker. Unfortunately, coffee filters of the type generally known in the art have a natural tendency of collapsing into the filter basket during the brewing process. When this occurs, it is not uncommon for the coffee grounds, tea leaves or other substances being brewed to be displaced from the collapsed filter into the freshly brewed beverage. The existence of such coffee grounds, tea leaves or other particles in the freshly brewed beverage is undesirable and may necessitate disposing of the freshly brewed beverage and repeating the brewing process, which can be wasteful and time-consuming and is therefore undesirable.

Consequently, a need exists for a simple, safe and economical device capable of substantially maintaining the pre-brewing shape of the filter walls during the brewing process, thereby eliminating or reducing the amount of coffee grounds, tea leaves or other substances being brewed from being deposited in the freshly brewed beverage. The filter fence of the present invention provides users with a simple, safe and economical device capable of substantially maintaining the pre-brewing shape of the filter walls during the brewing process, thereby eliminating or reducing the amount of brewed particles in the freshly brewed beverage. The filter fence of the present invention further provides users with a food grade, flexible filter fence that is reusable, relatively easy to manufacture and safe to use.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, is a filter fence for applying outward pressure to a filter to prevent it from collapsing within a filter basket during the brewing process preferably comprised of a continuous strip of food grade silicone or other substance approved by the Food and Drug Administration (“FDA”) in the general shape of a ring that is both flexible and generally heat resistant up to temperature of 450 degrees Fahrenheit. The filter fence further has shape memory characteristics such that it is capable of substantially returning to its initial shape after being manipulated into a different shape so that the filter fence can be installed within a filter in a filter basket.

More specifically, in the preferred embodiment of the present invention, the filter fence is folded inward or otherwise temporarily deformed for placement within a filter that has been installed within a filter basket. Upon the user's release of the temporarily deformed filter fence, the filter fence of the present invention resorts to substantially its original shape and assists in substantially maintaining the pre-brewing shape of the walls of the filter against the filter basket during the brewing process, thereby eliminating or reducing the amount of brewed particles in the freshly brewed beverage.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates a perspective view of prior art coffeemaker with a filter basket of a type commonly known in the art.

FIG. 2 illustrates a perspective view of a preferred embodiment of the filter fence of the present invention installed within a prior art filter which is, in turn, installed in a prior art filter basket.

FIG. 3 illustrates a perspective view of a preferred embodiment of the filter fence of the present invention in its natural state.

FIG. 4 illustrates a perspective view of the filter fence of FIG. 3 in a temporarily deformed condition for insertion within a filter (not shown) within a filter basket (not shown) of a coffeemaker (not shown).

FIG. 5 illustrates a top view of the filter fence of FIG. 3 upon its successful installation within a filter within a filter basket.

FIG. 6 illustrates a sectioned elevational view of the filter fence upon its successful installation within a filter within a filter basket depicted in FIG. 5.

FIG. 7 illustrates an elevational view of a second embodiment of the filter fence of the present invention.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof.

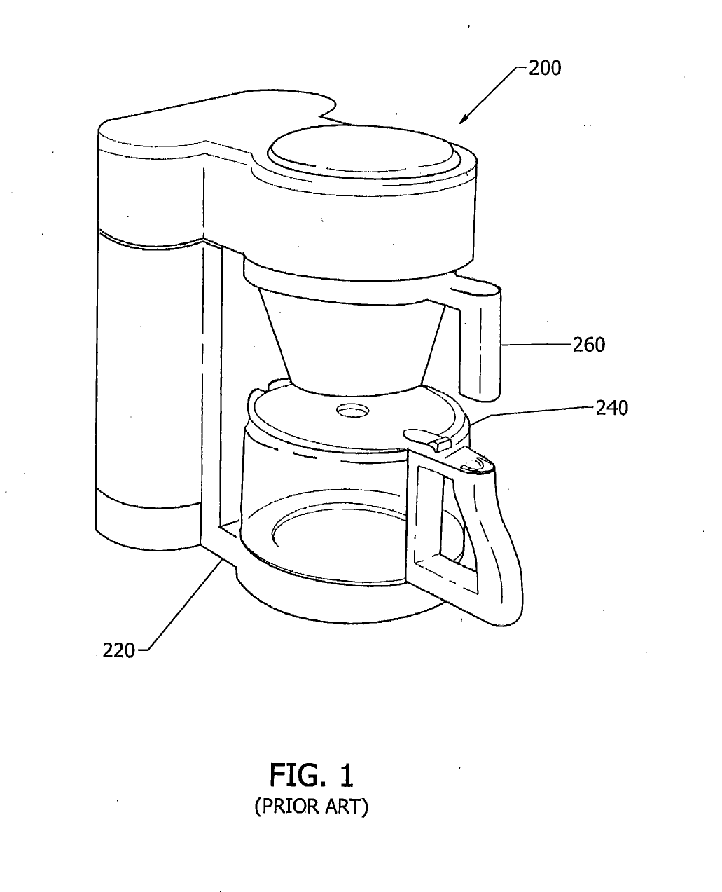

To better understand the benefits of the filter fence 100 of the present invention, FIG. 1 illustrates a perspective view of prior art coffeemaker 200 upon which filter fence 100 could be installed. More specifically, the coffeemaker 200 depicted in FIG. 1 comprises a base 220, a coffee pot 240, and a filter basket 260. Filter basket 260 comprises an opening 262 therein and an inner wall 264 for receipt of a standard type filter 280 such as a coffee filter. More specifically, filter 280 is inserted within opening 262 of filter basket 260 and adjacent to inner wall 264. Coffeemaker 200, base 220, coffee pot 240, and filter basket 260 are all of a type known in the art.

Filter 280 can be any type of filter known in the art such as a paper or crepe paper coffee or tea filter. Filter 280 comprises an opening 282 therein for receipt of coffee grounds, tea particles, or other substance (not shown) to be used in the brewing process.

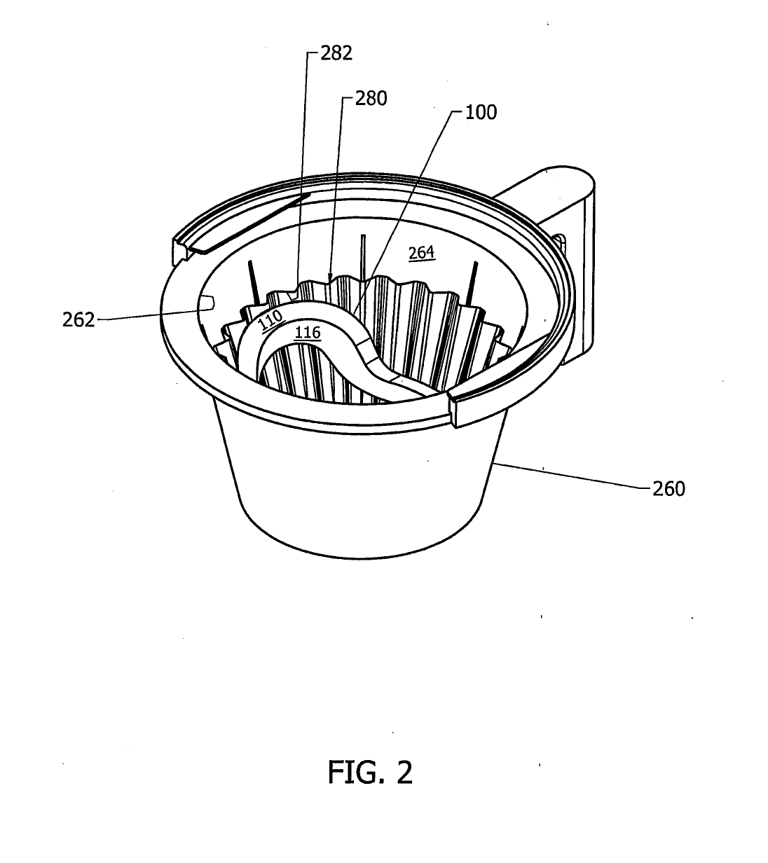

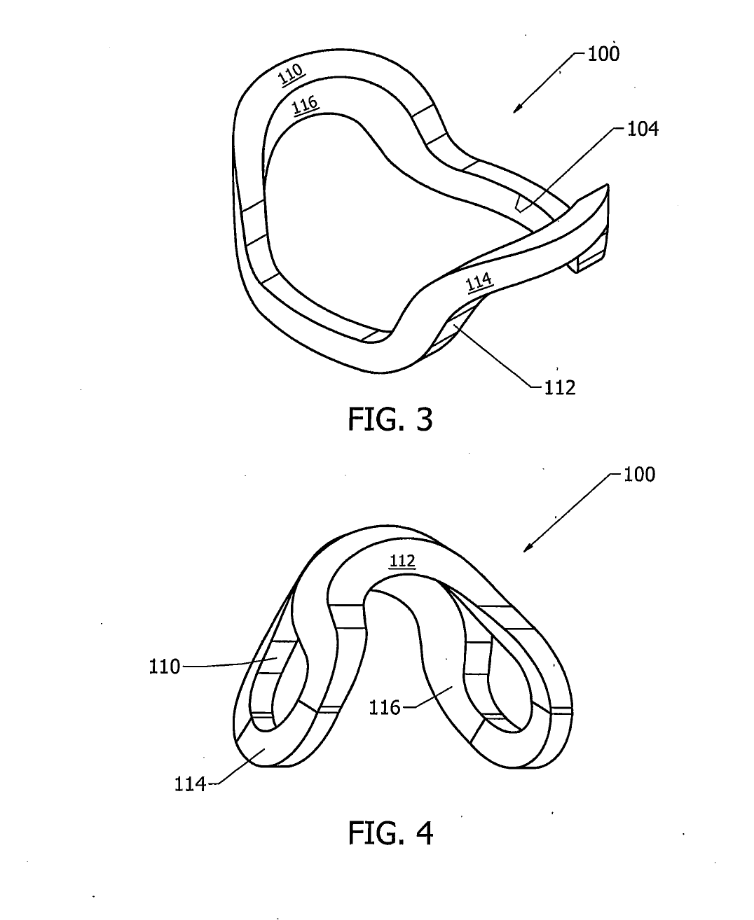

Inasmuch as the opening 262 of most filter baskets 260 are generally circular in shape as depicted in FIG. 2, filter fence 100 is preferably also generally circular or oval in shape as best shown in FIG. 3, and is preferably comprised of a continuous strip of food grade silicone, though filter fence 100 could be manufactured of other FDA approved substances that possess the herein described properties. Food grade silicone is well known in the art and readily available for use in the manufacturing of filter fence 100. Filter fence 100 is preferably both flexible and generally heat resistant to at least 450 degrees Fahrenheit, meaning that it will not melt or substantially deteriorate when exposed to temperatures less than 450 degrees Fahrenheit, as can typically be encountered in the brewing process.

Filter fence 100 further comprises a continuous opening 104 therein to permit coffee grounds and/or water to pass through opening 104 and be deposited into filter 280 during the brewing process as more fully described below. In a preferred embodiment, the outside diameter of filter fence 100 is between 3½ and 5½ inches, though it is acknowledged that filter fence 100 can be manufactured to almost any specification, shape and/or dimension provided that it fits snugly within opening 282 of filter 280 within filter basket 260, as best illustrated in FIG. 3.

Filter fence further comprises a top surface 110, a bottom surface 112, an outer surface 114 and an inner surface 116. In the preferred embodiment, the thickness of filter fence 100, measured from top surface 110 to bottom surface 112 is between ½ and 3 inches, though the thickness of filter fence 100 could vary outside of this range without affecting the overall concept of the invention. Similarly, the width of filter fence 100, measured from outer surface 114 to inner surface 116 is preferably between ½ and 1½ inches, though other widths could be used without affecting the overall concept of the invention, provided that the width is no so large as to substantially interfere with the depositing of the substance to be brewed and/or water into opening 282 of filter 280 in anticipation of the brewing process.

Having described the general purpose and physical characteristics of filter fence 100, its use will now be described. An individual (not shown) that desires to use filter fence 100 to brew a beverage such as coffee with coffeemaker 200 would simply insert a fresh filter 280 into opening 262 of filter basket 260. Once filter 200 has been properly installed within opening 262 of filter basket 260, the individual can then install filter fence 100 within opening 282 of filter 280 by applying gentle pressure to outer surface 114 of filter fence 100 so as to slightly and temporarily deform filter fence 100 so that the same can be inserted into place within opening 282 of filter 280 as best shown in FIG. 4. When the individual releases the pressure on filter fence 100, its shape memory characteristics permit filter fence 100 to substantially return to its original shape and outer surface 114 is adjacent and applying outward pressure to filter 280 thereby causing it to substantially remain in proper position adjacent to interior wall 264 of filter basket 260 during the brewing process. Importantly, the individual can insert the desired amount of fresh coffee grounds, tea leaves or other substance to be brewed into filter 280 prior to or after installing filter fence 100 within filter 280.

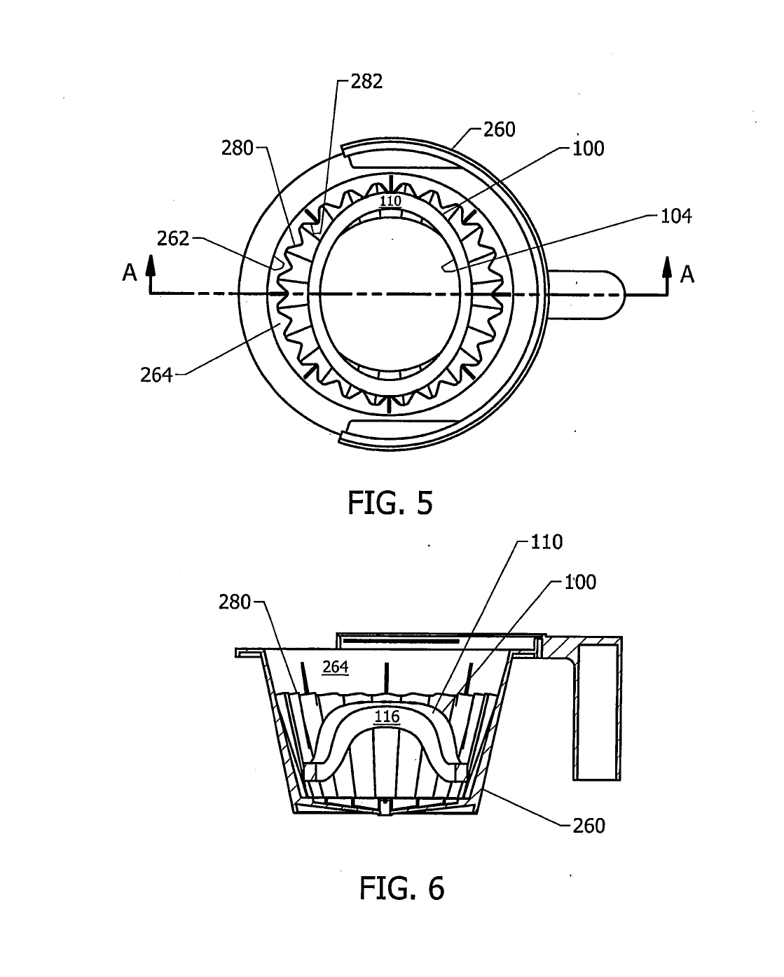

So that the installation and proper positioning of filter fence 100 within filter 280 can be better understood, FIG. 5 illustrates a top view of filter fence 100 upon its successful installation within filter 280 within filter basket 260, and FIG. 6 illustrates a sectioned elevational view of filter fence 100 upon its successful installation within filter 280 within filter basket 260.

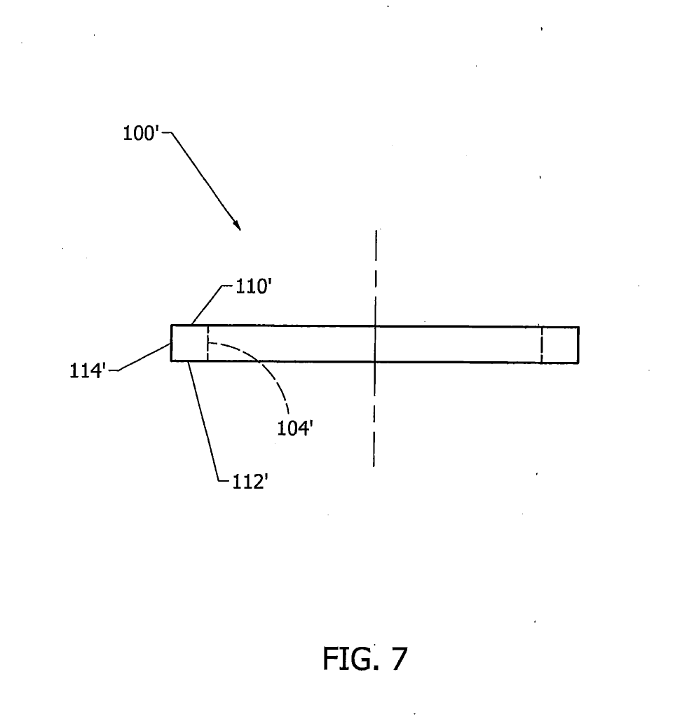

While the preferred embodiment of filter fence 100 is depicted in FIGS. 2 through 6 as being generally U-shaped from an elevational viewpoint, filter fence 100 can also be relatively flat as depicted in a secondary embodiment in FIG. 7, or any other configuration without affecting the overall concept of the present invention. More specifically, FIG. 7 depicts a second embodiment of filter fence 100′, which is comprised of a top surface 110′, a bottom surface 112′, an outer surface 114′ and an inner surface 116′. Filter fence 100′ functions and is installed within filter 280 within filter basket 260 in the same manner as is filter fence 100, which is described above.

By using filter fence 100 in the brewing process, the individual should be able to substantially reduce the amount of coffee grounds, tea particles or other substances that might otherwise be deposited into the freshly brewed beverage.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A filter fence for retaining a filter within a filter basket comprising an outer surface and an inner surface.

2. The filter fence of claim 1 wherein the filter fence is used as part of a brewing process.

3. The filter fence of claim 1 wherein the filter fence is comprised of silicone.

4. The filter fence of claim 1 wherein the filter fence has shape memory characteristics.

5. The filter fence of claim 3 wherein the filter fence is comprised of food grade silicone.

6. The filter fence of claim 1 wherein the filter fence is generally heat resistant.

7. A filter fence for retaining a filter within a filter basket comprising a continuous strip of silicone with shape memory characteristics.

8. The filter fence of claim 7 wherein the filter fence is used as part of a brewing process.

9. The filter fence of claim 7 wherein the filter fence further comprises an outer surface and an inner surface.

10. The filter fence of claim 7 wherein the filter fence has a continuous opening therein.

11. The filter fence of claim 7 wherein the filter fence is generally heat resistant.

12. An apparatus for brewing a beverage comprising:
a base;
a pot;
a filter basket;
a filter; and
a filter fence.

13. The apparatus of claim 12 wherein the filter fence is comprised of silicone.

14. The apparatus of claim 12 wherein the filter fence has shape memory characteristics.

15. The apparatus of claim 13 wherein the filter fence is comprised of food grade silicone.

16. The apparatus of claim 12 wherein the filter fence is comprised of a continuous strip of silicone with shape memory characteristics.

17. The apparatus of claim 12 wherein the filter fence is comprised of an outer surface and an inner surface.

18. The apparatus of claim 12 wherein the filter fence is generally heat resistant.

19. The filter fence of claim 12 wherein the filter fence has a continuous opening therein.

20. The filter fence of claim 12 wherein the filter fence is heat resistant to 450 degrees Fahrenheit.
